(19) United States
(12) Patent Application Publication
(10) Pub. No.: US 2015/0193773 A1
(43) Pub. Date: Jul. 9, 2015

(54) FINANCIAL CARD FRAUD ALERT

(71) Applicant: GLOBAL CYBERLINK TECHNOLOGIES, LLC, Spring, TX (US)

(72) Inventor: Esteban P. Mattioli, Spring, TX (US)

(73) Assignee: GLOBAL CYBERLINK TECHNOLOGIES, LLC, Spring, TX (US)

(21) Appl. No.: 14/590,116

(22) Filed: Jan. 6, 2015

Related U.S. Application Data
(60) Provisional application No. 61/924,383, filed on Jan. 7, 2014.

(51) Int. Cl. G06Q 20/40

(52) U.S. Cl. CPC G06Q 20/4016; G06Q 20/407

(57) ABSTRACT

A system and method directed to reducing the risk of fraud in financial card transactions. The system includes components for a second authorization on an independent communication channel for confirming financial transactions. The components include a second authorization module configured to receive an authorization request for a financial transaction and a software application operating on a mobile communications device configured to provide an interface for a cardholder. The software application is configured to exchange information with the second authorization module. The system being configured to provide criteria for which transactions require second authorization based on a cost threshold. The system is configured to deny a transaction when the second authorization request is not approved within a time limit. The method includes using the system.

### CROSS-REFERENCE TO RELATED APPLICATION

This application claims the benefit of U.S. Provisional Application No. 61/924,383 filed Jan. 7, 2014, which application is hereby incorporated by reference for all purposes in its entirety.

### BACKGROUND OF THE DISCLOSURE

1. Field of the Disclosure

This disclosure generally relates to the field of electronic financial transactions and, in particular, fraud protection for electronic financial card transaction.

2. Description of the Art

Financial card transactions make up a substantial portion of consumer financial transactions The popularity of financial transaction cards, such as credit cards and debit cards, has consistently increased since their inception. The exponential increase in worldwide financial card transactions had been closely followed by a parallel increase in related fraud. It is estimated that $11.27 billion was lost due to global card fraud in 2012 (The Nikon Report, August 2013, retrieved October 25, 2013), and this amount does not include the amount expended by consumers on fraud prevention measures. Fraud attempts may be made through on-line or face-to-face transactions, and losses tend to be higher for on-line transactions than face-to-face transactions. Security measures to prevent financial card fraud may be designed to operate before (pre-fraud prevention) or after (post-fraud prevention) an initial fraudulent charge has been made against the financial card.

### Post-Fraud Prevention

Post-fraud prevention involves preventing subsequent fraud from occurring after an initial fraud (or series of frauds) has been committed. Post-fraud prevention typically includes analyses of spending patterns and geographical usage of financial cards to profile a financial cardholder and to establish spending patterns for the financial cardholder. Financial card transactions that are out of the ordinary patterns may serve as a flag the financial card may have been wholly or partially compromised. Based on these deviations from the ordinary patterns, the financial card issuer may freeze the financial card or further track the deviations with the goal of identifying the perpetrator of the fraudulent transactions. Action based on the post-fraud analyses only take place after a suspicious pattern has developed, so while these measures they may prevent future fraud, they are not effective in preventing fraud that occurs before an identifiable pattern of suspicious transactions has developed.

Since legitimate transactions during the course of the card holder's financial card usage may appear to be suspicious, attempts to detect and deter unauthorized financial card usage can result m the financial card being automatically blocked when unusual or otherwise suspect spending occurs. Thus, even when the spending is by the legitimate financial cardholder, the cardholder's account may become frozen (locked) due to fraud prevention efforts. Then, the financial card holder must contact the card issuing company to have the card holder's account unfrozen (unlocked) if the transactions were in fact legitimately authorized. Unfortunately, the financial cardholder may not find out about the frozen status of the account until the financial card is rejected while being used to perform a legitimate transaction. This can result in inconvenience and embarrassment for the cardholder, who must then expend time contacting the financial card issuing company to have the financial account unfrozen (often while waiting to make the valid transaction).

If the financial card issuing company opts to contact the cardholder about suspicious transactions, instead of freezing the financial account or suspending operation of the financial card, then additional fraudulent transactions may take place while the financial card issuing company is attempting to resolve the suspicious transactions with the cardholder. The contact option is often used because it does not leave the cardholder without purchasing power while a question about the legitimacy of a transaction is being resolved, but it also leaves the credit card issuing company open to additional fraud in the event that the financial card is being used fraudulently.

### Pre-Fraud Prevention

Pre-fraud prevention includes security measures designed to reduce the risk of an initial fraud attempt from being successful. These security measures may require financial card validations such as a store clerk comparing the name of the financial card with the name on an alternative form of identification, comparing signatures on the transaction with a signature on the financial card, requiring the entry of a personal identification number (PIN), and requiring a financial card security code.

For security measures that require electronic matching of information input at the POS terminal with card holder data on file at the cardholder's financial institution (i.e. PINs), the validation is usually provided through the same communication channel through which the cardholder's account number is provided, instead of through an independent communication channel. For example, a financial card 3 or 4 digit security code is may be required when shopping on-line or by telephone. The use of the security code acts as a confirmation card is in physical possession of the buyer (who may or may not be a legitimate purchaser). Another method is the use of behavioral profile models in which deviations from typical spending patterns may prompt the financial institution to put charges on hold, Another method, used in e-commerce by financial services companies, such as American Express Merchant Network, Pay Pal and others, consists of creating consumer risk profiles that match key transaction elements such as Internet protocol, email and shipping addresses with stored data, including from previous purchases. There is a long series of other security features, included those incorporated into the production of the physical credit card itself, ranging from holograms to the data in the magnetic strip. E-commerce and other transactions going through payment processing networks with their own safety measures such as real time messaging services sold under the names Verified by Visa.® and MasterCard SecurityCode.®, still provide the purchaser authorization through the same channel by which the account data was received.

### Point-of-Sale (POS) Authorization—Single Channel

In an exemplary credit card transaction, a financial cardholder may attempt to make a payment at a POS terminal located at a merchant, office, or other suitable location. After the financial card's number has been input, the POS terminal then transmits a transaction request to a bank associated with the POS terminal (e.g., the merchant's bank). The merchant's bank then requests a payment from the card association network (for cards such as VISA, MASTERCARD, etc.). The card association network then requests authorization from the financial cardholder's bank (or other financial institution that issued the card such as a credit union). Along this single communication channel, the financial card number and other security codes (PIN, card security code, etc.) are transmitted. When the financial, cardholder's bank confirms that payment should be made, a transmission from the financial cardholder's bank authorizes the transaction at the POS terminal.

### Point-of-Sale (POS) Authorization Double Channel (Includes Additional Independent Channel Validation)

While there are advantages to introducing a second channel, such as for an independent channel validation, to reduce the risk of fraud, it is not as common a practice as the single channel communication methods. Separating sensitive information between two communication channels to complete the transaction authorization may be particularly advantageous for the detection and prevention of fraudulent transactions. If the account number and authorization detail of a payment card have been compromised, a parts attempting fraud still cannot execute a financial transaction without approval from the second (alternate or external) channel. When a fraudulent transaction takes place, the cardholder may be immediately notified that fraudulent activity is occurring and may be able to act to deny the transaction before any losses are incurred.

In U.S. Pat. Pub. No. 2011/0302083, a system is proposed which provides an independent communication to a mobile communication device to request confirmation of a transaction that has been requested at a POS terminal. The transaction and the authorization request have separate communication paths. A response to the authorization request is required for approval and denial of the transaction by a financial accounting system. In the event of a failure to receive a response, the financial accounting system may wait until an access processing network default time out is met, which may result in a denial for failure to receive a response. The mobile communication device user has no information as how long the user has to respond to the authorization request, and the user has no way to immediately reverse the account locking from the device or to change the amount limit that triggers the authorization request.

In U.S. Pat. No. 8,078,538, a system is proposed that provides an independent communication to a mobile communications device to confirm a transaction that has been requested at a POS terminal when a fraud warning condition has been met. The response to the independent communication authorizes or denies the transaction, and a failure to respond also provides authorization for the transaction.

What is needed is a fraud security system and method that reduces the risk of fraud occurring using a second, independent communication channel, where the cardholder has an option to require a second authorization prior to the approval of the transaction request based on the POS terminal request and where authorization on the second channel is only required for selected transactions based on conditions configured by the cardholder. The absence of the second authorization, when required, results in a denial of the transaction request.

### BRIEF SUMMARY OF THE DISCLOSURE

In aspects, the present disclosure relates to electronic financial transactions. Specifically, the present disclosure is related to fraud protection for electronic financial card transactions.

One embodiment according, to the present disclosure includes a method of validating financial card transactions, the method comprising: receiving an authorization request from a point of sale terminal to approve a financial card transaction; transmitting a notification of the transaction request to a mobile communications device of a financial cardholder when an amount of the transaction request exceeds a threshold amount; transmitting an acceptance of the transaction request to the point of sale terminal when an acceptance response to the notification is received from the mobile communications device; and transmitting a denial of the transaction request to the point of sale when a denial response to the notification is received from the mobile communications device or no response to the notification is received within a time limit. The financial card transaction may include one or more of a credit card transaction and a debit card transaction. The point of sale may include one or more of a merchant and an automated teller machine. The method may include an additional step of receiving the threshold amount from the financial cardholder. The method may include the additional steps of receiving a freeze instruction from the financial card holder; and transmitting the denial of the transaction based on the received freeze instructions.

Another embodiment according to the present disclosure includes a system for validating financial card transactions, the system comprising: a transaction request receiving mechanism configured to receive an authorization request from a point of sale for completing a financial card transaction; a notification mechanism configured to transmit a notification of the transaction request to a mobile communications device of a financial cardholder when an amount of the transaction request exceeds a threshold amount; a receiving mechanism configured to receive a response to the notification from the mobile communications device; and a transaction request validation mechanism configured to transmit the acceptance of the transaction request to the point of sale when the response indicates acceptance of the transaction and to transmit a denial of the transaction request when the response indicates denial of the transaction or no response is received within a time limit. The financial card transaction may include one or more of a credit card transaction and a debit card transaction. The point of sale may include one or more of: a merchant and an automated teller machine. The system may also include one or more of: i) a threshold amount mechanism configured to receive the threshold amount from the financial cardholder and ii) an override mechanism configured to deny the financial card transaction after receiving a freeze instruction from the financial cardholder.

Another embodiment according to the present disclosure includes a non-transitory computer-readable medium product, the non-transitory computer-readable medium containing instructions thereon that, when executed by at least one processor, perform a method, the method comprising: receiving an authorization request from a point of sale for completing a financial card transaction; transmitting a notification of the transaction request to a mobile communications device of a financial cardholder when an amount of the transaction request exceeds a threshold amount; transmitting an acceptance of the transaction request to the point of sale when an acceptance response to the notification is received from the mobile communications device; and transmitting a denial of the transaction request to the point of sale when a denial response to the notification is received from the mobile communications device or no response to the notification is received within a time limit. The non-transitory computer-readable medium may include one of i) a ROM, ii) an EPROM, iii) an EEPROM, iv) a flash memory, v) an F-RAM, vi) an MRAM, vii) an optical disk, and viii) a magnetic hard drive.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding, reference should be made to the following detailed description of the embodiments, taken in conjunction with the accompanying drawings, in which like elements have been given like numerals, wherein:

FIG. 1 a data flow diagram of a financial card authorization process according to one embodiment of the present disclosure;

FIG. 2 is a diagram of a software interface on a mobile communications device for communication with a an authorization module in the financial card authorization process of FIG. 1; and

FIG. 3 is a flow chart of a method for reducing the risk of fraud during financial card transactions according to one embodiment of the present disclosure.

### DETAILED DESCRIPTION OF THE DISCLOSURE

In aspects, the present invention relates to electronic financial transactions. Specifically, the present invention is related to reducing the risk of fraud involving consumer financial card transactions. The present invention is susceptible to embodiments of different forms. There are shown in the drawings, and herein will be described in detail, specific embodiments with the understanding that the present invention is to be considered an exemplification of the principles and is not intended to limit the present invention to that illustrated and described herein.

In one aspect, the present disclosure is directed to a system that uses a module installed in a financial transaction authorization chain that includes a second communication channel. This second channel is used for communication with a software application on a cardholder's mobile communication device. The software application is configured to request action by the the cardholder to accept or reject the transaction. This substantially increases the security during the authorization process, before fraud can occur. The system does not interfere with the preexisting sequential steps involved in the authorization process that occur along the first channel, and the system is independent of the clearing and settlement processes that take place after a transaction is authorized.

Due to the portability and mobility of smart phones, they can be used at the merchant's place of business. Additionally, the system incorporates the security features of the mobile communication device to enhance the fraud prevention aspects. In particular, the consumers may be much more protective and mindful of their smart phone and may have employed additional layers of security provided by their mobile operating system that can serve as additional barriers to fraud. In the past, a fraudster could commit a fraud using only 1a) a credit card or 1b) a credit card number and security code; however, in some aspects of the disclosed system, the fraudster would need to obtain 1a) the credit card or 1b) the credit card number and security code, 2) the smart phone, and 3) the passcode to the smart phone in order to commit a fraudulent transaction.

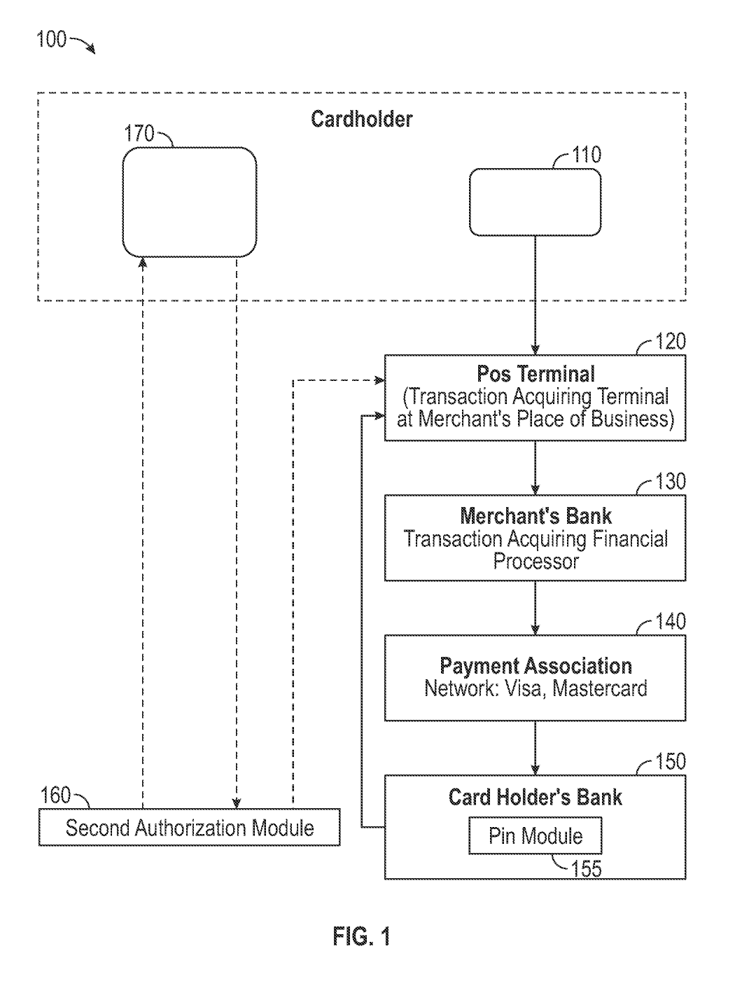

FIG. 1 shows a simplified data flow diagram for a financial card purchase system 100. The financial card 110 is assumed to be under the control of the cardholder; however, this will not be the case in the event of a fraudulent transaction. The financial card 110 may be used at a POS terminal 120. The POS terminal 120 may be at a physical location (store, office, etc.) for card-present transactions illustrated here. However, the system may also apply to card-not-present transactions such as mail orders or on-line (e-commerce) payments. The POS terminal 120 may transmit a request for authorization for a transaction to a merchant bank 130. The request for authorization sent from the POS terminal 120 includes, as a minimum, the identification number for the financial card that is associated with the cardholder's account. The merchant bank 130 may then transmit the financial card information to the card association payment network 140 (e.g., Visa, Inc., MasterCard, Inc.). The card association payment network 140 may then transmit the authorization request to the cardholder's financial institution that issued the card, bank 150 in the illustration. The data path between the POS terminal 120 and the card holder's bank 150 is common to both single and dual loop authorization processes.

One aspect of the system 100 is that it is configured to implement a dual loop authorization process for selected transactions. In a single loop authorization process, the card holder's bank 150 would send an authorization to the POS terminal 110 as soon as the PIN information, security code, signature, and other usual single authorization conditions are met. In the system 100, a second authorization path continues from the card holder's bank 150 to a second authorization module 160. The second authorization module 160 is configured to receive the request for transaction authorization transmitted to the financial account access system of the cardholder's bank 150 in the embodiment illustrated here, that shows the second authorization module 160 embedded in the bank's financial infrastructure. In alternative embodiments, the second authorization module 160 may be located at any level of the account authorization access system; for instance, the payment association network for cards.

The second authorization module 160 is also configured to transmit a notification of the transaction request to a mobile communications device 170. The mobile communications device 170 is configured to execute a software application, which is configured to interact with the second authorization module 160. The application is configured to display the notification of the transaction request and provide an ability to respond and control other features within the second authorization module 160, including, but not limited to, one or more of: 1) entering a PIN for the second authorization loop, 2) displaying the transaction amount, 3) accepting the transaction, 4) denying the transaction, 5) freezing the financial card account, 6) unfreezing the financial card account, 7) monitor the time left to control the account, and 8) resetting an amount for the transaction alert limit.

Through the application, the user of the mobile communications device 170, presumed to be the card holder, may choose to accept or deny the transaction authorization request at the mobile communications deice 170. The mobile communications device 170 is configured to transmit a response containing the acceptance/denial of the transaction request to the second authorization module 160. The second authorization module 160 is configured to receive the acceptance/denial response from the mobile communications device 170 within a selected period of time. The second authorization module 160 is configured to transmit the second (final) authorization to the POS terminal 120 based on the response. The second authorization module 160 is also configured to transmit a denial in the event that the acceptance denial response front the mobile communications device 170 is not received within the selected period of time. The period of time (time limit) may be based on a processing time delay associated with the card holder's bank processing the transaction request and is set by the administrator of the second authorization module 160. The addition of the second authorization loop managed by the second authorization module 160 requires personal intervention of the card holder in selected transactions. The second authorization module 160 may store transaction limits set by the card holder to determine which transactions require second authorization. For example, a card holder may set a transaction limit to $200 so that only transactions exceeding $200 will require the second authorization.

The transaction limit may be set on a per transaction basis, a cumulative basis for a set period of time, or a combination thereof. For example, the card holder may set a cumulative limit for a financial card at $3000 for the current billing cycle, so that if a transaction would cause the $3000 cumulative total is reached or exceeded for that billing cycle, then that transaction and all additional transactions for that billing cycle will require a second authorization. In a combination example, the transaction limit may be set to i) $200 while the cumulative total is under $3000 and ii) $50 while the cumulative total is at or above $3000.

The second authorization module 160 may be configured to receive changes to the transaction limit from the mobile communications device 170. The mobile communications device 170 may be any suitable mobile computing platform with wireless communication capability, including devices such as smartphones. A smartphone adds to the standard mobile phone advanced computing capability, high-resolution touchscreens and high-speed data access. The communication between the mobile communications device 170 and the second authorization module 160 may be conducted over any suitable wireless communication method, including, but not limited to, cellular data and Wi-Fi.

The notification transmitted from the second authorization module 160 to the mobile communications device 170 may include information about the transaction, including, but not limited to, one or more of: i) time of the transaction, ii) merchant name (POS terminal name), iii) transaction item description, iv) quantity of items, v) individual transaction amount and vi) total transaction account.

Herein, the second authorization module 160 is shown embedded in the financial account access system of the card holder's bank 150, This is exemplary and illustrative only, as the second authorization module 160 may be disposed in other places of the access chain such as the financial card association network 140. The second authorization module 160 may be disposed in alternative institutions so long as the transaction request information may be received by the second authorization module 160 and then a request for response/receipt of response to the mobile communications device 170 may be completed before a system imposed time limit results in an accidental denial of the transaction.

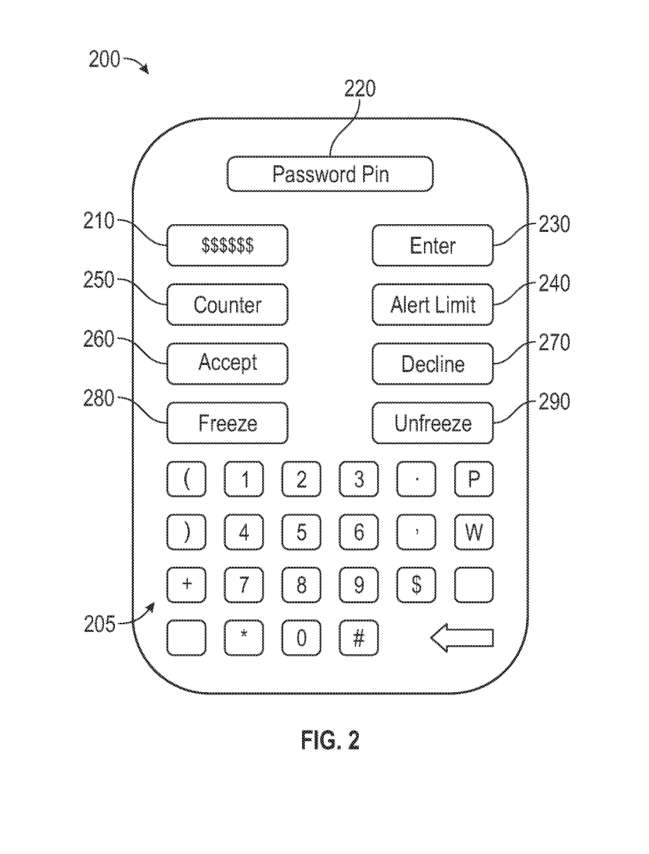

FIG. 2 shows an exemplary interface 200 configured to allow interaction between the financial card holder and the second authorization module 160 via the mobile communications device 170. The software application on the mobile communications device 170 may be configured display the interface 200. The interface 200 may include buttons or softkeys (virtual or actual) for performing dedicated functions within the application. The application may display the transaction request 210. The card holder may access the application through optional password protection 220 (such as a PIN), or the card holder may rely on the password protection provided by the operating system of the mobile communications device 160 (if any). The enter button 230 may be used to accept the password. The interface 200 may also display an alert limit 240. The alert limit 240 (or threshold amount) may be set on the mobile communications device 170 or at the card holder's bank 150. The interface 200 may include a counter 250 providing an indication of the amount of time remaining before the system 100 automatically declines the financial transaction request. The interface may include an acceptance button 260 and a decline button 270, which, respectively, accept or deny the financial transaction request. The interface 200 may include a freeze button 280 and an unfreeze button 290, which are, respectively, configured to transmit a freeze and an unfreeze command to the second authorization module 160 to have the card holder's account frozen/unfrozen. The interface 200 may include an input keyboard 205 to support data entry in any of the buttons or fields of the interface 200. The interface 200, along with the software application, may be downloaded to the mobile communication device 170.

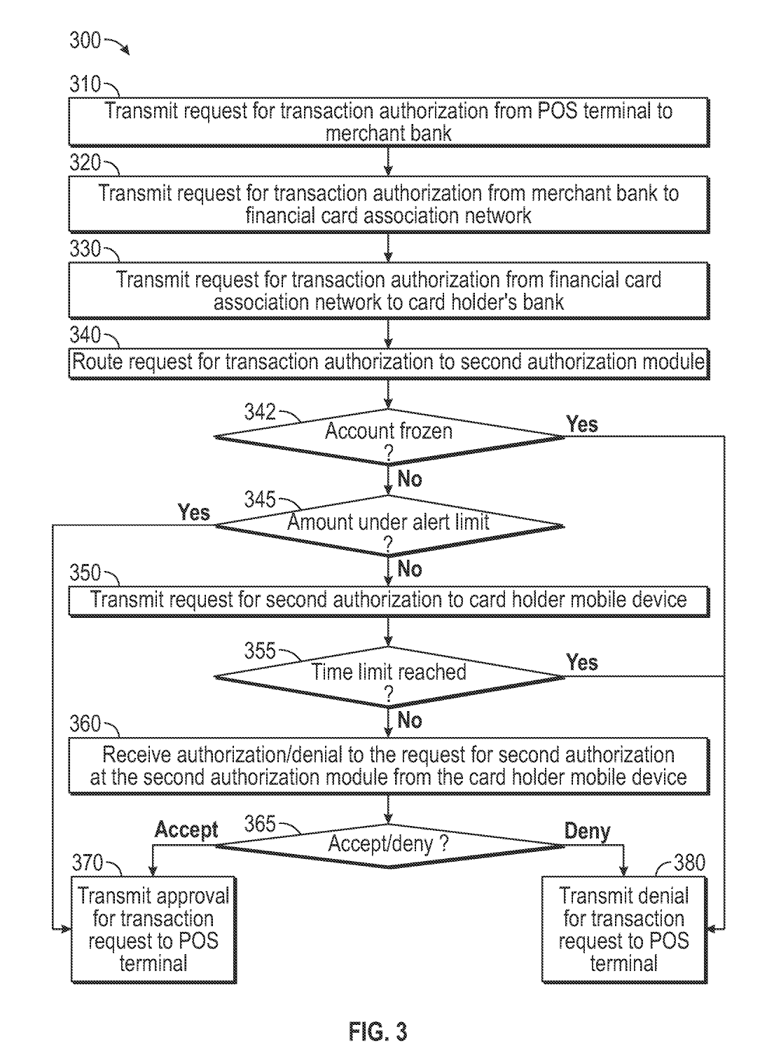

FIG. 3 shows a flow chart of the financial authorization process 300 for one embodiment of the system 100. In step 310, a request for authorizing a transaction using a financial card is transmitted from the POS terminal 120 to the merchant bank 130. In step 320, the authorization request is passed from the merchant bank 130 to the financial card association network 140. In step 330, the authorization request is passed from the financial card association network 140 to the card holder's bank 150. In step 340, the received request at the card holder' bank 150 is routed to the second authorization module 160. In step 342, the frozen/unfrozen status of the card holder's account is checked. When the card holder's account is frozen, the second authorization module 160 transmits a denial to the POS terminal (step 380). When the card holder's account is not frozen, the method proceeds to step 345. In some embodiments the step 342 may be performed at the card holder' bank 150 prior to routing of the transaction request to the second authorization module 169. In step 345, the amount of the transaction request is compared with the alert limit 240 set in the second authorization module 160. When the transaction amount is below the alert limit, the second authorization will default to acceptance of the transaction and transmit the acceptance to the POS terminal (step 370). When the transaction amount is at or above the alert limit, the second authorization module will proceed to step 350. In step 350, the second authorization module transmits a notification to the mobile communications device 170. The notification will supply the transaction request information to the software application on the mobile communications device 170 and request an acceptance or denial of the transaction from the card holder. While the request is waiting for a decision from the card holder, a clock is running against a time limit in the second authorization module 160. In step 355, the time on the clock is checked against the time limit. If the time limit is reached, then the transaction is automatically denied (step 380). In step 360, the acceptance/denial from the mobile communications device 170 is received by the second authorization module 160 and processed if the time limit has not been reached. In step 365, the result of the acceptance/denial response is processed by the second authorization module 160. In step 370, an acceptance is received and transmitted to the POS terminal 120. In step 380, a denial is received and transmitted to the POS terminal 120.

The embodiments of the systems and methods described herein may be implemented in hardware or software, or a combination of both. The second authorization module 160 may be realized as a computer program configured to be executed on one or more programmable computers each comprising at least one processor, a data storage system (including volatile and non-volatile memory and/or storage elements) at least one input device, and at least one output device. For example and without limitation, the one or more programmable computers may be application servers. The software application on the mobile communications device 170 may be realized as a computer program and may be configured to be executed by the mobile communications device 170. The mobile communication device 170 may include, without limitation, one or more of a cellular telephone, a smartphone, and a personal digital assistant. The term mobile communication device is used herein with its most generic meaning, and it is contemplated that, in some embodiments, any suitable mobile communications device with software processing capability and wireless communications (cellular data, Wi-Fi, etc.) may be used as mobile communication device 170. It is also contemplated that, in some embodiments, the software application may employ additional security features including biometrics and facial recognition.

In an alternative embodiment, the second authorization module 160 may be configured to communicate with a simple cell phone (without smart phone computing capability) or even a land line phone (such as a touch tone handset), where an automated voice message and voice alert menu provide functionality for a user to provide an acceptance or a denial for a transaction using either voice commands or the key pad on the phone.

Each such computer program is preferably stored on a suitable storage media or a device (e.g. ROM, EPROM, EEPROM, flash memory, F-RAM, MRAM, optical disk, magnetic hard drive, etc.) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims

What is claimed is:

1. A method of validating financial card transactions, the method comprising:
receiving an authorization request from a point of sale terminal to approve a financial card transaction;
transmitting a notification of the transaction request to a mobile communications device of a financial cardholder when an amount of the transaction request exceeds a threshold amount;
transmitting an acceptance of the transaction request to the point of sale terminal when an acceptance response to the notification is received from the mobile communications device; and
transmitting a denial of the transaction request to the point of sale when a denial response to the notification is received from the mobile communications device or no response to the notification is received within a time limit.

2. The method of claim 1, wherein the financial card transaction is a credit card transaction.

3. The method of claim 1, wherein the financial card transaction is a debit card transaction.

4. The method of claim 1, wherein the point of sale is a merchant.

5. The method of claim 1, wherein the point of sale is an automated teller machine.

6. The method of claim 1, further comprising:
receiving the threshold amount from the financial cardholder.

7. The method of claim 1, further comprising:
receiving a freeze instruction from the financial card holder; and
transmitting the denial of the transaction based on the received freeze instructions.

8. A system for validating financial card transactions, the system comprising:
a transaction request receiving mechanism configured to receive an authorization request from a point of sale for completing a financial card transaction;
a notification mechanism configured to transmit a notification of the transaction request to a mobile communications device of a financial cardholder when an amount of the transaction request exceeds a threshold amount;
a receiving mechanism configured to receive a response to the notification from the mobile communications device; and
a transaction request validation mechanism configured to transmit the acceptance of the transaction request to the point of sale when the response indicates acceptance of the transaction and to transmit a denial of the transaction request when the response indicates denial of the transaction or no response is received within a time limit.

9. The system of claim 8, wherein the financial card transaction is a credit card transaction.

10. The system of claim 8, wherein the financial card transaction is a debit card transaction.

11. The system of claim 8, wherein the point of sale is a merchant.

12. The system of claim 8, wherein the point of sale is an automated teller machine.

13. The system of claim 8, further comprising:
a threshold amount mechanism configured to receive the threshold amount from the financial cardholder.

14. The system of claim 8, further comprising:
an override mechanism configured to deny the financial card transaction after receiving a freeze instruction from the financial cardholder.

15. A non-transitory computer-readable medium product, the non-transitory computer-readable medium containing instructions thereon that, when executed by at least one processor, perform a method, the method comprising:
receiving an authorization request from a point of sale for completing a financial card transaction;
transmitting, a notification of the transaction request to a mobile communications device of a financial cardholder when an amount of the transaction request exceeds a threshold amount;
transmitting an acceptance of the transaction request to the point of sale when an acceptance response to the notification is received from the mobile communications device; and
transmitting a denial of the transaction request to the point of sale when a denial response to the notification is received from the mobile communications device or no response to the notification is received within a time limit.

16. The non-transitory computer-readable medium product of claim 15, wherein the non-transitory computer-readable medium is one of it a ROM, ii) an EPROM, in) an EEPROM, iv) a flash memory, v) an F-RAM, vi) an MRAM, vii) an optical disk, and viii) a magnetic hard drive.
